(19) United States
(12) Patent Application Publication
(10) Pub. No.: US 2013/0176202 A1
(43) Pub. Date: Jul. 11, 2013

(54) MENU SELECTION USING TANGIBLE INTERACTION WITH MOBILE DEVICES

(71) Applicant: Michael Gervautz, Vienna (AT)

(72) Inventor: Michael Gervautz, Vienna (AT)

(73) Assignee: QUALCOMM INCORPORATED, San Diego, CA (US)

(21) Appl. No.: 13/348,480

(22) Filed: Jan. 11, 2012

(51) Int. Cl. G09G 5/00

(52) U.S. Cl. 345/156

(57) ABSTRACT

An electronic device (such as a mobile device) displays on a screen of the device, a live video captured by a camera in the device. While the live video is being displayed, the device checks if a first predetermined condition is satisfied. When the first predetermined condition is satisfied the device displays a menu on the screen. The menu includes multiple menu areas, one of which is to be selected. While the menu is being displayed on the screen, the device checks if a second predetermined condition is satisfied, e.g. by a movement of a predetermined object in real world outside the device. When the second predetermined condition is satisfied, the device displays on the screen at least an indication of a menu area as being selected from among multiple menu areas in the displayed menu.

### FIELD

This patent application relates to devices and methods for interfacing with a user.

### BACKGROUND

In mobile devices such as a smart phone, a camera phone or a tablet computer it is known to display a live video of an object 110 (such as a business card) in the real world on a screen 101 of a mobile device 100 (see FIG. 1).

It is further known to use a technology commonly known as augmented reality, to overlay content (most often 3D content) on a video being displayed by such a mobile device. The content can be displayed stationary relative to a portion of an image on the screen indicative of an object in the real world. For example, if the object in the real world is a saucer, a virtual object in the form of a cup can be overlaid on the saucer (“target”) in the image on the screen. Movement of the real-world saucer relative to the camera can result in movement on the screen of both the cup and the saucer together (kept stationary relative to one another).

In mobile devices of the type described above, when a user is interacting with augmented reality by reaching into a real world scene to move a virtual object displayed on the screen, if a user wants to issue a command to the mobile device, the user needs to use a normal interface (e.g. touch screen, joystick or microphone) of the mobile device. The inventor of the current patent application believes that use of the normal interface of a mobile device takes time and adds additional mental load on the user, which is a drawback of certain prior art.

An article entitled “Visual Code Widgets for Marker-Based Interaction” by Michael Rohs describes visual codes (two dimensional barcodes) that can be recognized by camera-equipped mobile devices, in real time in a live camera image. Visual code equipped widgets make it possible to design graphical user interfaces that can literally be printed on paper or shown on large-scale displays. Interaction typically takes place as follows: the user finds a visual code widget, for example in a magazine. She starts a recognizer application on her phone or PDA and aims at the widget. The widget appears on the device screen in view finder mode and is updated in real time as the user moves the device relative to the widget. The state of the widget is superimposed over the camera image. Menus are widgets that trigger a function upon selection of a menu item. Pen-based input can be used for selection of the menu item. For devices without pen-based input, pressing the joystick button can take a picture so the camera image freezes, and the user has the opportunity to cycle through the menu selection using the joystick. One more click submits the selected menu item. Accordingly, it appears that menus of the type described by Michael Rohs are useful for interfacing a user with objects that are either static in the real world or too heavy for the user to move in the real world.

An article entitled “Mixed Interaction Spaces—a new interaction technique for mobile devices” by Hansen et al. describes Mixed Interaction Space (MIXIS) which uses the space surrounding a mobile device for its input. The location of a mobile device is tracked by using its built-in camera to detect a fixed-point in its surroundings. This fixed-point is then used to determine the position and rotation of the device in the 3D space. The position of the mobile phone in the space is thereby transformed into a 4 dimensional input vector. In one example, movement of the mobile device with the user's head as the fixed-point is mapped to actions in a graphical user interface on the device. MIXIS eliminates the need to use two dimensional barcodes or visual codes as described above. However, moving a relative heavy device like a tablet, to generate input vectors, can lead to fatigue.

### SUMMARY

In several aspects of various embodiments, an electronic device (such as a mobile device) displays on a screen of the device, a live video captured by a camera in the device. While the live video is being displayed, the device checks if a first predetermined condition is satisfied. When the first predetermined condition is satisfied the device displays a menu on the screen. The menu includes multiple menu areas, one of which is to be selected.

In certain embodiments, while the menu is being displayed on the screen, the device checks if a second predetermined condition is satisfied, e.g. by a movement of a predetermined object in real world outside the device. When the second predetermined condition is satisfied, the device displays on the screen at least an indication of a menu area as being selected from among multiple menu areas in the displayed menu.

Therefore, a user of the device can easily select a menu area in a menu, by simply moving a predetermined object in the real world. Accordingly, in some embodiments, the user does not need to touch the screen to make a selection. Instead, in several such embodiments, the user holds a mobile device in one hand and moves the predetermined object in the other hand, to make a selection of a menu area in a menu displayed by the mobile device.

Various embodiments are implemented as a system including a camera and a screen operatively connected to one another. The system includes means for checking if a first predetermined condition is satisfied, while a live video captured by the camera is being displayed on the screen, means for displaying on the screen at least a menu including multiple menu areas when at least the first predetermined condition is satisfied, means for checking if a second predetermined condition is satisfied by a movement of a predetermined object in real world, while the menu is being displayed on the screen and means for displaying on the screen at least an indication of a menu area among the menu areas as being selected, when at least the second predetermined condition is satisfied.

Several embodiments are implemented as a mobile device that includes a camera, a memory operatively connected to the camera, a screen operatively connected to the memory to display a live video captured by the camera, and one or more processors operatively connected to the memory. The memory includes instructions to the one or more processors, including instructions to check whether a first predetermined condition is satisfied while the live video is being displayed on the screen, instructions to display on the screen at least a menu including multiple menu areas when at least the first predetermined condition is found to be satisfied by execution of the instructions to check, instructions to check whether a second predetermined condition is satisfied by a movement of a predetermined object outside the mobile device, while the menu is being displayed on the screen and instructions to display on the screen at least an indication of a menu area as being selected when at least the second predetermined condition is satisfied. Certain embodiments are implemented as a non-transitory computer readable storage medium that includes the just-described instructions (i.e. instructions described in the current paragraph) for execution by one or more processors of a mobile device or other such electronic device.

It is to be understood that several other aspects of the embodiments will become readily apparent to those skilled in the art from the description herein, wherein it is shown and described various aspects by way of illustration. The drawings and detailed description are to be regarded as illustrative in nature and not as restrictive.

### BRIEF DESCRIPTION OF THE DRAWING

FIG. 1 illustrates a mobile device 100 displaying on a screen 101, a live video of a real world object 110 in the prior art.

FIGS. 2A and 2B illustrate, in flow charts, one or more acts performed by an electronic device 200 in several embodiments, when interfacing with a user.

FIG. 3A illustrates, in a perspective view, use of a predetermined object 302 (in this example, a business card) to cause a menu 304 to be displayed on a screen of a mobile device 300 that performs one or more acts illustrated in FIGS. 2A-2B.

FIG. 3B illustrates, in an elevation view along the Y direction in FIG. 3A (e.g. a horizontal direction parallel to ground) relative distances in the Z direction (e.g. vertical direction perpendicular to ground) between the mobile device 300, the predetermined object 302 and an item 391 (in this example, a cup of steaming coffee) in a scene 390 in the real world.

FIG. 3C illustrates, in a block diagram, software modules and data in a memory 319 of mobile device 300 that are used when performing the one or more acts illustrated in FIGS. 2A and 2B.

FIG. 3D illustrates, in another perspective view similar to FIG. 3A, relative distances in the X direction (e.g. another horizontal direction parallel to ground and perpendicular to the Y direction) between mobile device 300 and a right-most edge of the predetermined object 302, before and after movement of predetermined object 302 by the right hand 303R while mobile device 300 is kept steady by the left hand 303L.

FIG. 4A illustrates, in a block diagram similar to FIG. 3C, one specific embodiment wherein software (also called “app”) 320 includes modules 321, 322, 323 and 324 each of which is respectively activated by selection of a corresponding one of four menu areas 341, 342, 343 and 344 of a menu 340.

FIG. 4B illustrates, in a block diagram similar to FIG. 4A, four menu areas 361, 362, 363 and 364 of a menu 360 that are displayed in response to selection of menu area 344 to activate module 324 in the specific embodiment illustrated in FIG. 4A.

FIG. 5A illustrates, in yet another perspective view similar to FIG. 3A, use of a predetermined object 302 to cause an additional menu 503 to be displayed in some of the described embodiments.

FIG. 5B illustrates, in a flow chart similar to FIGS. 2A-2B, acts performed to display the additional menu 503 of FIG. 5A.

FIG. 6 illustrates, in a block diagram, mobile device 300 of the type described above, in some aspects of the described embodiments.

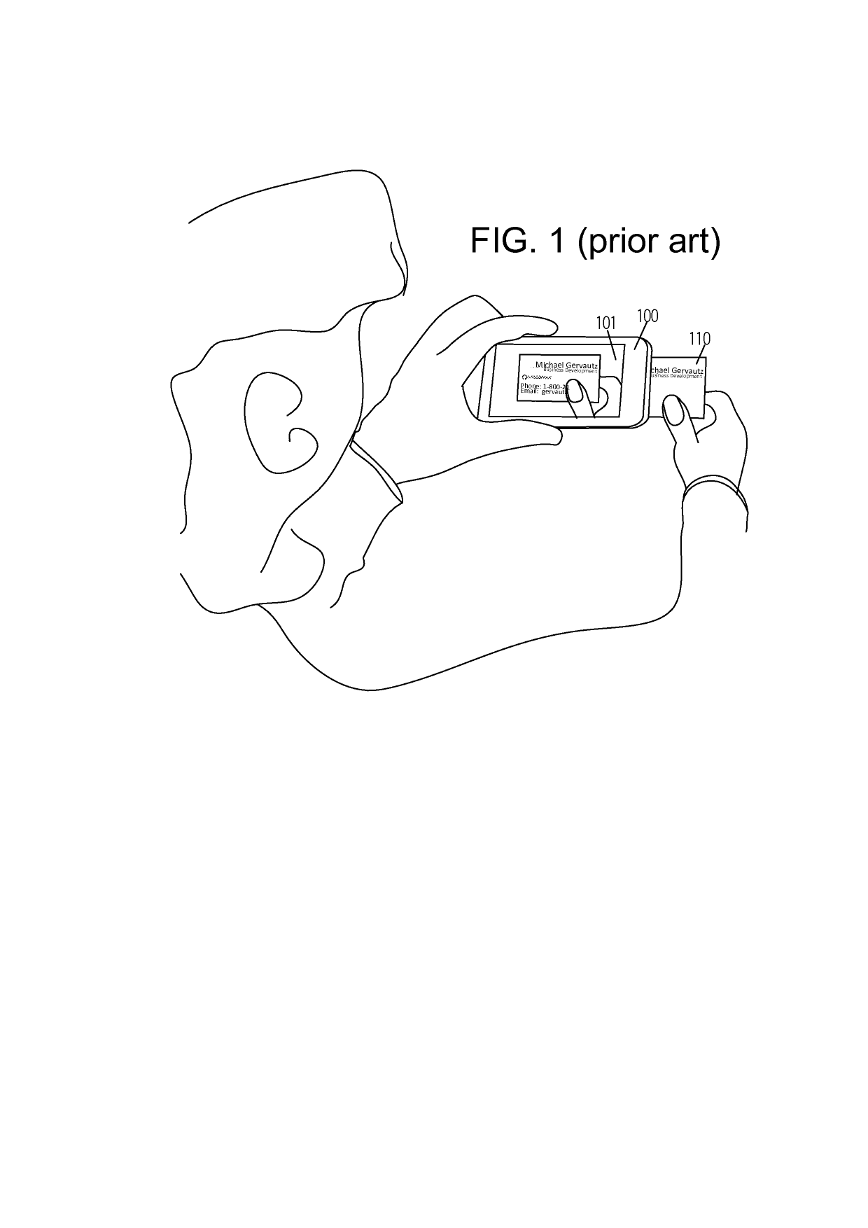

### DETAILED DESCRIPTION

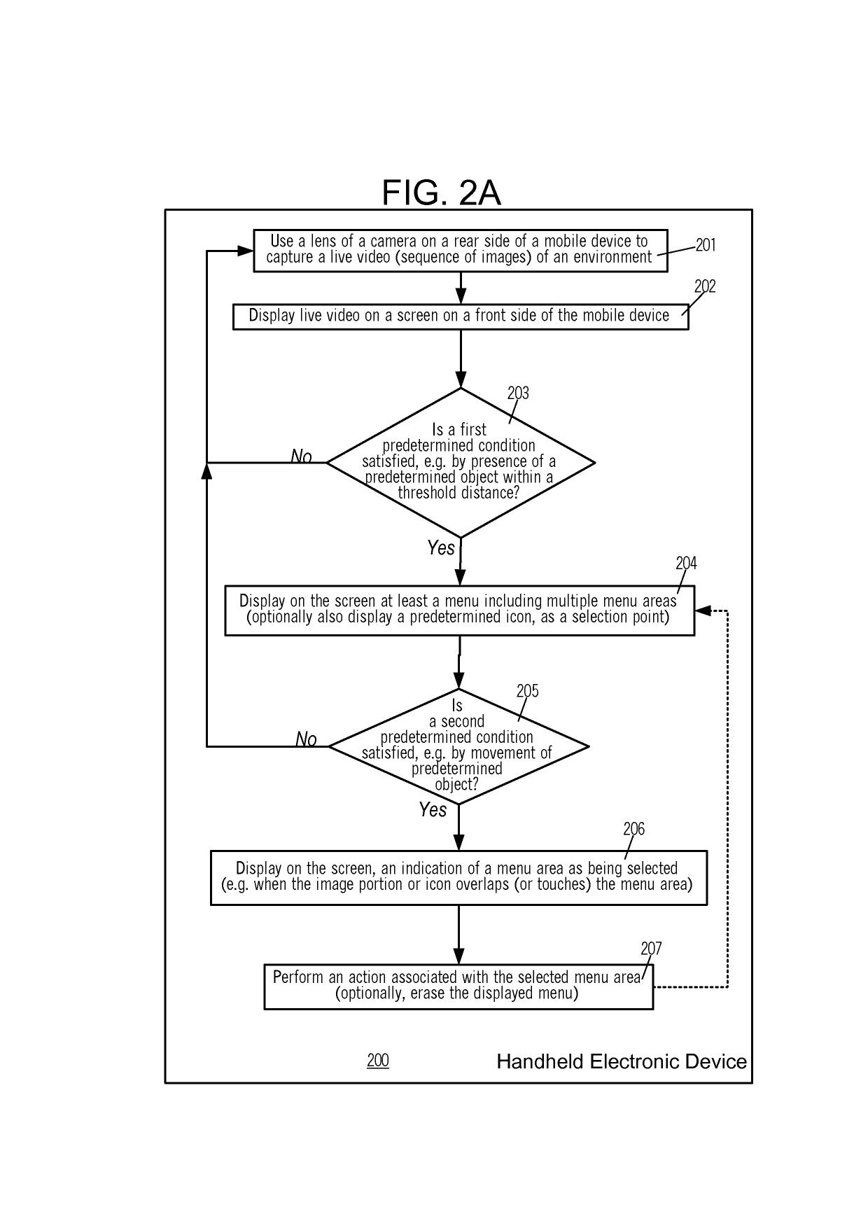

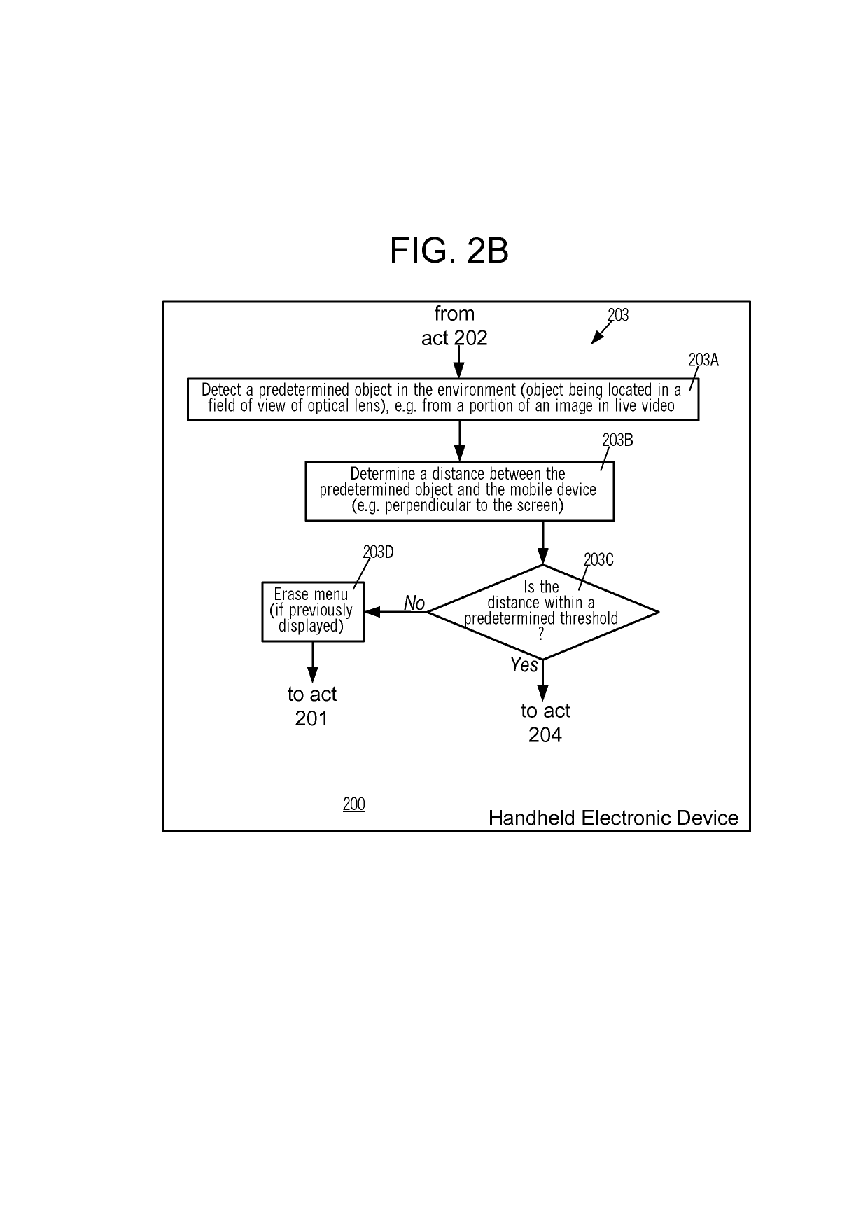

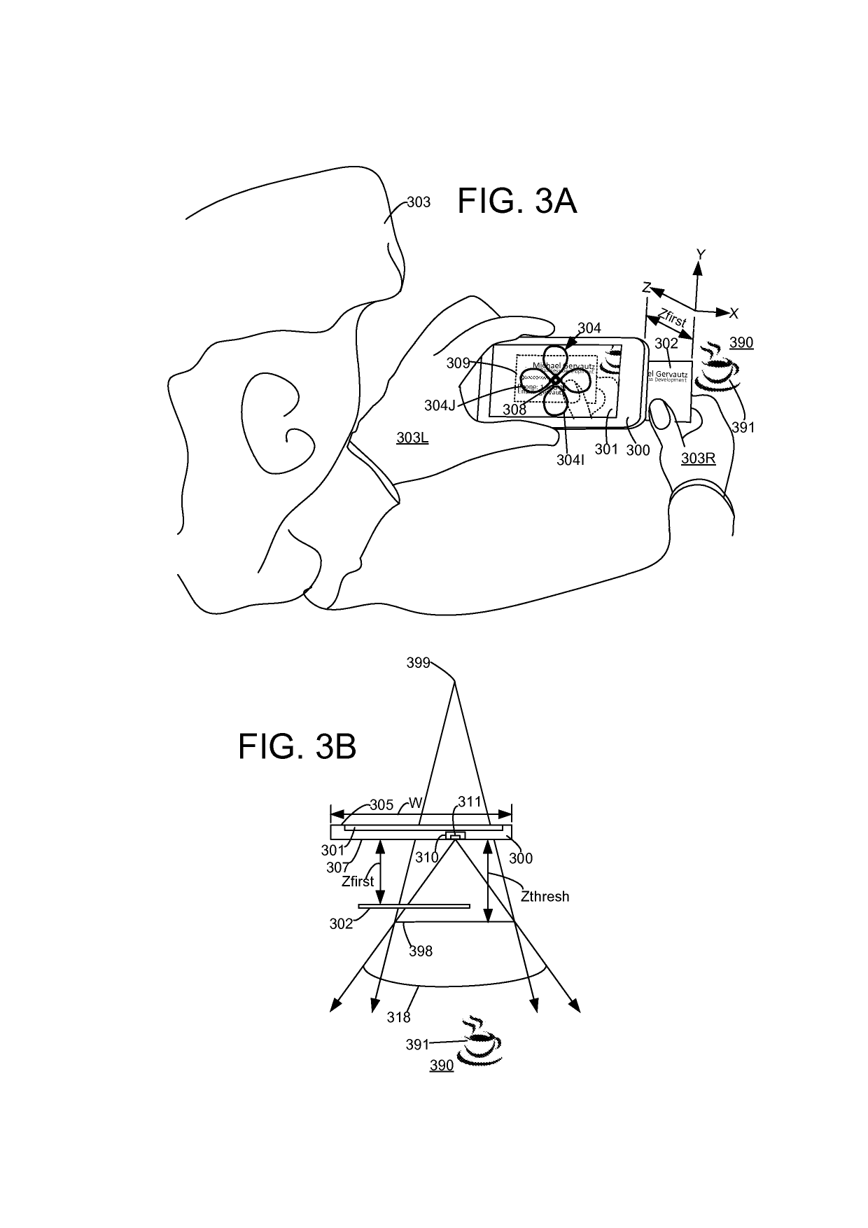

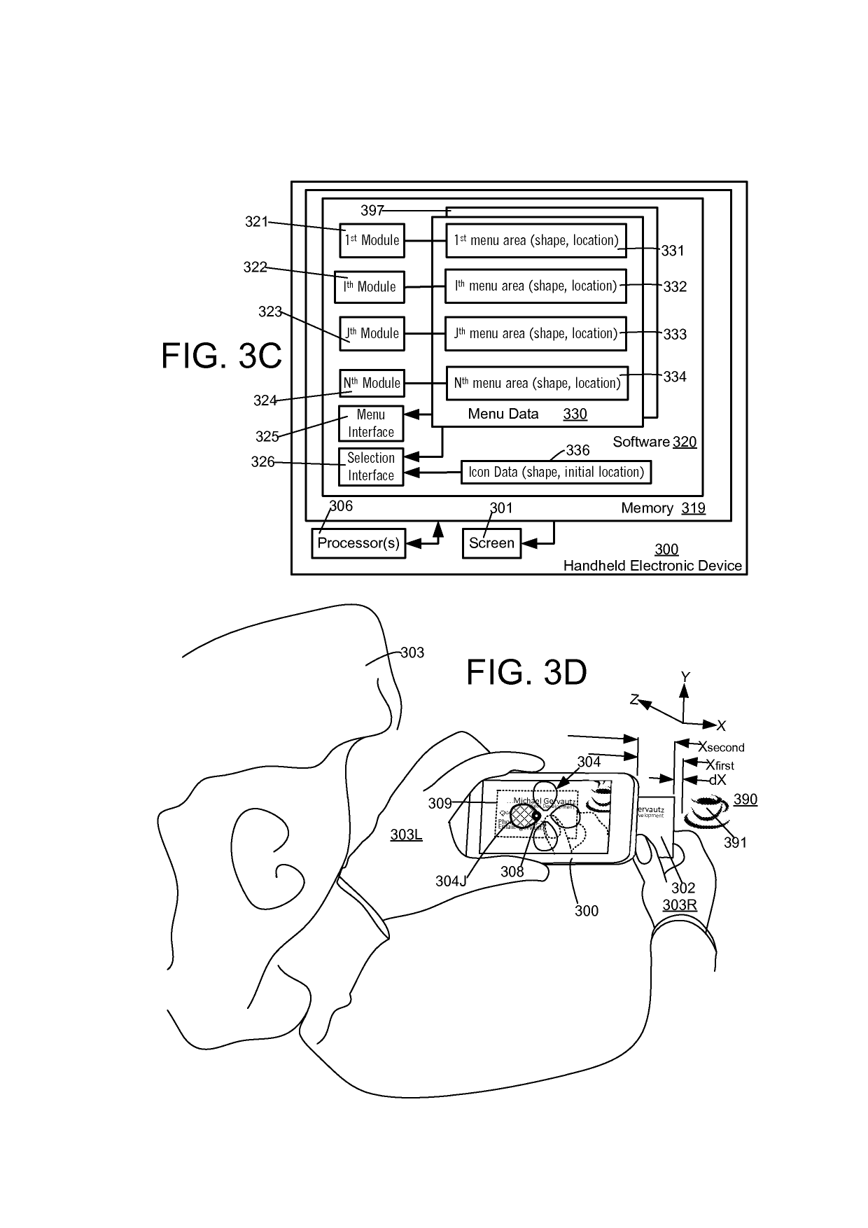

In several aspects of various embodiments, an electronic device and method use a camera on a rear side of the electronic device (an example of which is mobile device 300 in FIG. 3A, such as a cell phone) to capture a live video of an environment in real world outside the electronic device (see act 201 in FIG. 2A) and display the live video on a screen located on a front side of the electronic device (see act 202 in FIG. 2A). Such an electronic device 200, which performs a method of the type illustrated in FIG. 2A, is small enough and light enough to be held by a human in one hand, and for this reason referred to below as a handheld electronic device 200. Handheld electronic device 200 of some embodiments is used by a human (also called “user”) with another object (also called “predetermined object”) that is either already in another hand of that user or can be easily taken into the other hand and moved easily relative to handheld electronic device 200. Illustrative examples of handheld electronic device 200 include: (1) smart phone, (2) camera phone, or (3) tablet computer.

During the display of live video of the real world environment, handheld electronic device 200 checks if a first predetermined condition is satisfied (see act 203 in FIG. 2A). The first predetermined condition which is checked in act 203 can be different in different embodiments. In some embodiments of act 203, handheld electronic device 200 checks for presence of a predetermined object in close proximity of handheld electronic device 200, i.e. within a predetermined threshold distance therefrom. In several embodiments, the predetermined object whose proximity is being checked by handheld electronic device 200 in act 203 is identified within (and therefore known to) handheld electronic device 200 ahead of time, prior to performance of act 203.

A predetermined object, whose proximity is being detected in act 203 may or may not contain electronics, depending on the embodiment. Illustrative examples of a real world object that is sufficiently small and light to be held in a human hand and which can be used in many embodiments as a predetermined object to satisfy a predetermined condition of the type illustrated in act 203 include: (1) business card, (2) credit card, (3) pencil, (4) paper clip, (5) soda can, (6) spoon, (7) key, (8) mouse, (9) cell phone, (10) remote control, or (11) toy. Therefore, any such predetermined object, whose proximity is detected in act 203 is not necessarily a traditional input device, such as a wireless mouse, although a wireless mouse can be used as the predetermined object in some embodiments of the type described herein.

Other embodiments of act 203 may perform other tests to additionally or alternatively check whether a first predetermined condition is satisfied, e.g. 1) whether a voice command is received or 2) whether a test is satisfied for proximity of one predetermined object to another predetermined object. For example, a distance in an image in the live video between a credit card and a business card, of less than 1 cm satisfies the first predetermined condition of act 203 of some embodiments. Depending on the embodiment, handheld electronic device 200 may check either a single condition or multiple conditions in act 203, such as (a) presence of a predetermined object in an image of live video and (b) presence of a specific pattern on the predetermined object that was found to be present as per (a). Therefore, in one example of such embodiments, a first predetermined condition is satisfied only when a credit card is detected in live video that is displayed by electronic device 200 and furthermore when the credit card carries a specific two-dimensional bar code (e.g. the credit card 's 2D bar code may uniquely identify, for example, a specific financial institution that issued the card).

When the first predetermined condition is satisfied in act 203, handheld electronic device 200 displays a menu on its screen (see act 204 in FIG. 2A). The menu includes multiple menu areas, one of which is to be selected. In some embodiments, during act 204, the handheld electronic device 200 also displays a predetermined icon (such as a circle) to be used as a selection point. The predetermined icon is displayed at a predetermined location relative to the menu, e.g. at a center thereof. Note that in other embodiments, no icon is displayed. When the first predetermined condition is not satisfied in act 203, handheld electronic device 200 returns to performing act 201 (described above), e.g. after erasing a previously-displayed menu.

In certain embodiments, while the menu is being displayed on the screen, handheld electronic device 200 checks if a second predetermined condition is satisfied during such display (see act 205 in FIG. 2A). The second predetermined condition which is checked in act 205 can be different in different embodiments. In some embodiments, handheld electronic device 200 uses movement of the predetermined object (detected in act 202) in the real world outside the handheld electronic device 200 to perform act 205. Other embodiments may use receipt of a voice command, either alternatively or additionally, in checking for satisfaction of a second predetermined condition in act 205. Therefore, various embodiments may use different combinations of first and second predetermined conditions of the type described herein.

When the second predetermined condition is found to be satisfied in act 205, the handheld electronic device 200 displays on its screen at least an indication of a menu area as being selected, from among multiple menu areas in the displayed menu (see act 206). Thereafter, in act 207, handheld electronic device 200 performs an action that is associated with menu area that was selected and optionally erases the displayed menu (see act 203D). In some embodiments, when the second predetermined condition is not satisfied in act 203, handheld electronic device 200 returns to performing act 201 (described above).

As noted above, an object whose proximity is detected in act 203 is predetermined, e.g. the object is identified to handheld electronic device 200 by a user ahead of time, prior to acts 201 and 202. This predetermined object is detected within the live video being captured as per act 203, in some embodiments by a method illustrated in FIG. 2B, as follows. Specifically, in act 203A, handheld electronic device 200 uses augmented reality (AR) functionality therein to detect the presence of the predetermined object in the environment, e.g. within a field of view of an optical lens in handheld electronic device 200. Next, in act 203B, handheld electronic device 200 uses augmented reality (AR) functionality therein to determine a distance between the predetermined object and the mobile device. In certain embodiments, a distance Zfirst between the object and the device is measured in a direction along a Z axis which is oriented perpendicular to the screen of handheld electronic device 200, although in other embodiments the distance is measured independent of direction.

Thereafter, in act 203C, handheld electronic device 200 checks if the distance is within a predetermined threshold (e.g. Zthresh illustrated in FIG. 3A). If the answer in act 203C is yes, then handheld electronic device 200 performs act 204 (described above). If the answer in act 203C is no, then handheld electronic device 200 performs act 201 (describe above), after erasing any menu that has been previously displayed (as per act 203D). Note that act 203 may be performed differently in other embodiments, e.g. instead of using an optical lens, a radar may be used to emit radio waves and to detect reflections of the emitted radio waves by a predetermined object. Also in some embodiments, near field communication (NFC) is used in act 203 to detect a predetermined object.

Handheld electronic device 200 described above in reference to FIGS. 2A and 2B can be implemented by any combination of hardware and software as will be readily apparent to the skilled artisan in view of this detailed description. In some embodiments, handheld electronic device 200 is implemented as exemplified by mobile device 300 (e.g. a smart phone) described below in reference to FIGS. 3A-3D.

Mobile device 300 is configured to display on screen 301, a predetermined menu 304 formed by four drop shaped areas (such as areas 304I and 304J of screen 301 in FIG. 3A which are shown in the shape of a drop of water) and optionally an icon 308 that is to be used as a selection point. Note that in some embodiments, menu 304 initially appears on screen 301 right on the spot where image 309 of an object 302 is displayed on screen 301, as soon as object 302 (which may be any predetermined object, such as a business card) enters the vicinity of mobile device 300 as described below in reference to FIG. 3B.

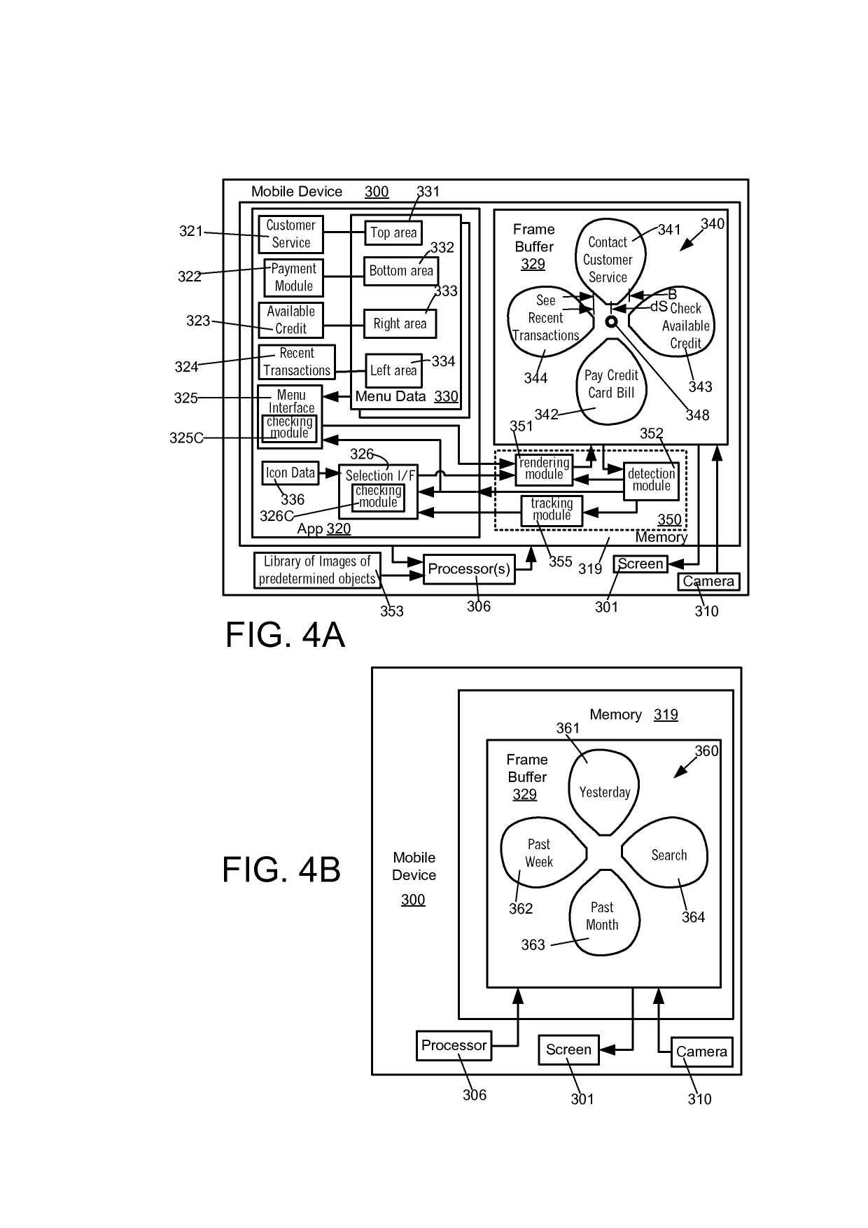

In several embodiments, a threshold distance Zthresh (see FIG. 3B) is selected ahead of time, e.g. by a designer of hardware and/or software in device 300. Specifically, in some embodiments, threshold distance Zthresh is predetermined to be a distance between an optical lens 311 of a camera 310 at a rear side 305 of mobile device 300 and a plane 398, such that object 302 in the vicinity of mobile device 300 is displayed on screen 301 at a front side 305 of mobile device 300 without any scaling, i.e. a plane of 1:1 experience when viewed by a human eye at point 399 (FIG. 3B). In embodiments of the type illustrated in FIG. 3B, one or more processors and memory (not shown in FIG. 3B, see FIG. 4A) are sandwiched between the front and rear sides 305 and 307 of mobile device 300, and operatively coupled to screen 301 and camera 310. In such embodiments, when located at any distance along the Z axis that is less than Zthresh, object 302 is displayed scaled up on screen 301, i.e. image 309 on screen 301 is displayed larger than (or enlarged relative to) object 302 (e.g. 20% larger), when object 302 is at a distance Zfirst<Zthresh. In these embodiments, when object 302 is located at any distance (along the Z axis) larger than Zthresh, object 302 is displayed scaled down on screen 301 (e.g. 10% smaller). Note that not only are an object's X and Y dimensions scaled up or down depending on the distance from camera 310 along the Z axis, but any movement of the predetermined object in the X and Y directions is also similarly scaled. Hence, when Zfirst<Zthresh, movement of object 302 is scaled up into a corresponding movement of an image 309 of object 302 in the live video displayed on screen 301.

Typically, in several embodiments, threshold distance Zthresh is predetermined to be a number that is of the same order of magnitude as a dimension (e.g. width W) of mobile device 300, which is a hand-held device in such embodiments. In situations wherein Z first <Zthresh, object 302 is within the vicinity of mobile device 300, such that a combination of camera 310 and screen 301 in device 300 operate together as a magnifying lens. Configuring device 300 to operate as a magnifying lens while displaying menu 304, by selection of an appropriate value of threshold distance Zthresh, enables a user of device 300 to perform movements on object 302 in the real world that are small relative to corresponding movements of image 309 (also called “target”) on screen 301. Therefore, a user can make a small movement of object 302 by moving the user's right hand 303R in the real world in order to make a corresponding movement of icon 308 sufficiently large to cause a menu area on screen 301 to be selected.

For example, as described below, a movement dX along the negative X direction in FIG. 3D of object 302, from an initial position at Xfirst to a final position at Xsecond results in a corresponding movement dS of image 309 in the negative X axis on screen 301. Specifically, in this example, movement dS of image 309 on screen 301 occurs from an initial position shown in FIG. 3A (as shown by icon 308 at the center of menu 304), to a final position in FIG. 3D (as shown by icon 308 overlapping the left menu area 3041). As noted above, the movement dS of image 309 (with icon 308 moving identically on screen 301) is n*dX, wherein n>1 is a scaling factor that depends on distance Z between object 302 and device 300. The distance dS through which image 309 moves (and hence icon 308 moves) in order for the second predetermined condition to be satisfied (as per act 205) is illustrated in FIG. 4A, although not shown in FIGS. 3A and 3D to improve clarity.

Depending on the embodiment, movement dS is predetermined to be smaller than an X or Y dimension of screen 301, e.g. dS<W/3 wherein W is the width of device 300. Moreover, dS is predetermined to be large enough to enable the user to make a selection of a menu area 304J from among multiple menu areas of menu 304 displayed on screen 301, e.g. dS>B/2 wherein B is the distance between two menu areas 343 and 344 (see FIG. 4A). Moreover, as noted above, dX=dS/n wherein n is the scaling factor, n>1. In an illustrative example of device 300, dS is predetermined to be 8 millimeters, and dX is predetermined to be 5 millimeters at a Z-axis distance of 10 cm between device 300 and object 302. In this example, Zthresh is 12 cm.

The specific value of Zthresh that is predetermined in various embodiments depends on multiple factors, such as an angle (also called “opening angle”) (e.g. 60° degrees in FIG. 3B) that defines a field of view 318 of lens 311. Note that in such embodiments, presence of object 302 in the vicinity of mobile device 300 occurs when a portion of object 302 enters field of view 318 (in addition to being at distance Zfirst <Zthresh), sufficiently for the portion to be detected by device 300 (i.e. identified to be a portion of object 302 using a library of images) as per some embodiments of act 203 to cause menu 304 to be displayed on screen 301 as per act 204 (FIG. 2A).

In some aspects of the described embodiments, software 320 (also called “app”) of mobile device 300 displays menu 304 stationary relative to screen 301, and icon 308 is displayed stationary relative to image 309 (or a portion thereof) captured from predetermined object 302. In some embodiments of software 320 (also called “application software” or simply “app”), menu 304 is rendered on screen 301 by invoking augmented reality (AR) functionality of mobile device 300 using menu data 330 (FIG. 3C) in a memory 319 coupled to screen 301 and processor 306. Depending on the embodiment, the augmented reality (AR) functionality of mobile device 300 can be implemented in hardware, software, firmware or any combination thereof. A specific implementation of augmented reality (AR) functionality of mobile device 300 is not a critical aspect in several embodiments.

Referring to FIG. 3C, menu data 330 in memory 319 of device 300 includes data 331-334 (such as XY coordinates on screen 301 defining shape and location) for a corresponding one of 1^{st} . . . I^{th} . . . J^{th} and Nth menu areas in menu 304. Note that instead of XY coordinates being specified in data 331-334, mathematical functions can be used therein to identify shapes of the menu areas in menu 304, depending on the embodiment. Data 331-334 is used in device 300 by one or more processors 306 executing instructions in menu interface software 325 to prepare, in memory 319, intensities of pixels to be displayed as menu 304 on screen 301. Similarly, memory 319 includes icon data 336 (such as shape and initial location relative to menu 304) that is used by selection interface software 326 to prepare in memory 319, intensities of pixels to be displayed as a selection point (drawn as icon 308, shaped as a circle for example) on screen 301.

In several aspects of the described embodiments, selection interface 326 uses augmented reality (AR) functionality to move icon 308 automatically in response to movement of image 309. In several such embodiments, when movement of predetermined object 302 results in a position of the icon 308 touching or overlapping an area of menu 304, the second predetermined condition is satisfied. When the second predetermined condition is satisfied, selection interface 326 displays an indication on the screen 301 that the menu area is selected (e.g. by highlighting the menu area).

For example, menu area 304J of menu 304 is highlighted (as shown by cross-hatch shading in FIG. 3D) when the distance between object 302 and the device 300 in the X-direction is reduced from Xfirst to Xsecond (FIG. 3C) by movement in the real world through distance dX along the X-axis. Although a specific menu area 304J is shown as being selected in FIG. 3D, other such menu areas in menu 304 can be selected by appropriate motion of object 302 in the real world, in the X-Y plane. Note that in some embodiments of the type shown in FIG. 3D, the second predetermined condition does not take into account the distance Zfirst. Therefore, a menu area 304J is selected by the movement dX of object 302, so long as the first predetermined condition is satisfied (e.g. Zfirst <Zthresh and object 302 still within field of view of lens 311).

Referring back to FIG. 3C, each of the 1^{st} . . . I^{th} . . . J^{th} and Nth menu areas in menu 304 is typically associated (by data 331-334) with a corresponding one of 1^{st} . . . I^{th} . . . J^{th} and Nth software modules 321-324. Therefore, when a specific menu area 304J is selected, its corresponding software module, such as the J^{th} module is automatically invoked, thereby to perform an action as per act 207 (described above in reference to FIG. 2A).

Some embodiments of the type described above are implemented as illustrated by an example in FIGS. 4A and 4B for an app 320 that includes software called credit-card manager. Accordingly app 320 includes a number of software modules, such as customer service module 321, payment module 322, available credit module 323 and recent transactions module 324 that are correspondingly triggered by selection of respective menu areas 341-344 of a menu 340 that are shown in FIG. 4A in a frame buffer 329 in memory 319. Frame buffer 329 is used in the normal manner, to display on screen 301, such a menu 340 and icon 348 superposed on live video from camera 310 (e.g. to display menu 304 and icon 308 on screen 301 in FIG. 3A).

Pixel values for menu 340 and icon 348 are generated by software instructions of a rendering module 351 that are stored in memory 319 and executed by one or more processors 306 in the normal manner. When executing the instructions of rendering module 351, processor 306 receives input data from menu interface 325, which in turn uses menu data 331-334 to identify the shapes and positions of corresponding menu areas 341-344. Menu interface 325 of several embodiments typically includes a checking module 325C to perform act 203 as described above in reference to acts 203A-203D shown in FIG. 2B.

In addition to rendering module 351, memory 319 of several embodiments of the type illustrated in FIG. 4A also includes software instructions of a detection module 352 that are also executed by one or more processors 306 in the normal manner, to detect presence of object 302 in the vicinity of device 300, e.g. by comparison of an image from camera 310 (stored in frame buffer 329) with a library 353 of images. In several embodiments, library 353 is created ahead of time, e.g. by user configuration of app 320 by using camera 310 to generate images of one or more objects (such as business card, shown in FIG. 3A as object 302, a credit card, a pen, a paper clip, an AA battery etc) that are thereby predetermined to be associated with one or more menus of app 320 or other such apps. Depending on the embodiment, the images in library 353 are stored in a non-volatile memory of device 300, such as a hard disk or a static random access memory (SRAM), and optionally on an external computer (not shown) accessible wirelessly by mobile device 300 (e.g. via a cell phone network). Accordingly, some embodiments use library 353 to identify a predetermined object 302 from a live video by comparing at least a portion of an image in the live video with images in library 353 (of corresponding objects).

In addition to modules 351 and 352 described in the preceding two paragraphs, memory 319 of several embodiments of the type illustrated in FIG. 4A also includes software instructions of a tracking module 355 that are also executed by one or more processors 306 in the normal manner, to track movement of predetermined object 302 in the vicinity of device 300, e.g. by comparison of images from camera 310 over time. In several embodiments, the data output by tracking module 355 is used by a checking module 326C (shown in FIG. 4A) within selection interface 326 to perform act 205 (described above in reference to FIG. 2A).

Accordingly, in some embodiments, checking module 325C constitutes the means for checking if a predetermined condition is satisfied as per act 203, while a live video captured by the camera 310 is being displayed on the screen 301. In such embodiments, checking module 326C constitutes means for checking if another predetermined condition is satisfied e.g. as per act 205 by movement of the predetermined object 302 in real world, while the menu is being displayed on the screen. Depending on the embodiment, checking module 326C may check on movement of predetermined object 302 in the X-Y plane to trigger selection of a menu area within a displayed menu, or checking module 326C may check on movement of predetermined object 302 in the Z direction to trigger display of another menu.

Moreover, in such embodiments, rendering module 351 renders on screen 301 as per act 204, a first display of a menu comprising a plurality of menu areas when at least the first predetermined condition is satisfied. In some embodiments, rendering module 351 includes in the first display a predetermined icon 348 overlaid on a portion of image 309 of predetermined object 302 in the first display. In such embodiments, rendering module 351 moves the predetermined icon on the screen 301 in response to a signal indicative of movement of predetermined object 302 in X-Y plane in the environment in real world. Subsequently, rendering module 351 may render on screen 301 as per act 206, a second display of an indication of a menu area (in the plurality of menu areas) as being selected, when another predetermined condition is satisfied. Between the first and second displays, rendering module 351 may render several intermediate displays showing movement of an icon between menu areas. Alternatively or additionally, rendering module 351 may render on screen 301 a second menu comprising a second set of menu areas, to replace a first menu previously included in the first display, e.g. in response to another signal indicative of movement of predetermined object 302 in the Z direction.

The above described modules 351-353 are together included, in some embodiments, in software instructions 350 stored in memory 319 that when executed by processor(s) 306 implement augmented reality (AR) functionality. Note, however, that in alternative embodiments such augmented reality (AR) functionality is implemented by specialized circuitry in hardware of mobile device 300. In still other embodiments, such augmented reality (AR) functionality may be implemented external to mobile device 300, e.g. in an external computer (not shown) accessible wirelessly by mobile device 300 (e.g. via a cell phone network). Therefore, a specific manner in which modules 351-353 are implemented is not a critical aspect of several embodiments.

Accordingly, as shown in FIGS. 3A and 3D, a user 303 simply holds mobile device 300 steadily in left hand 303L and brings predetermined object 302 into the vicinity of device 300 using the right hand 303R to cause menu 340 (FIG. 4A) to be displayed on screen 301. The user 303 may then move their right hand 303R and thus predetermined object 302 through distance dX in the negative X direction while steadily holding mobile device 300 in the left hand 303L, thereby to select a menu area 344 that in turn results in recent transactions module 324 to be activated. Recent transactions module 324 may in turn also display its own menu 360 including menu areas 361-364. At this stage, user 303 can move their right hand 303R and thus object 302 through another similar movement, to select a duration (e.g. a day, a week, or a month), over which credit-card transactions were performed for display on screen 301. For example, credit-card transactions that occurred during the past day (in the last 24 hours) are displayed by a user's right hand 303R moving object 302 by distance dX in the positive Y direction, credit-card transactions that occurred in the past week are displayed by the user's hand 303R moving object 302 through distance dX in the negative X direction, credit-card transactions that occurred in the past month are displayed by the user's hand 303R moving object 302 through distance dX in the negative Y direction, and a credit-card transaction search function is activated by the user's hand 303R moving object 302 through distance dX in the positive X direction.

As noted above, in several embodiments of the type described herein, the user's left hand 303L is used to hold mobile device 300 steadily while performing movements on object 302. Even as object 302 is being moved by right hand 303R, the user's left hand 303L steadily holds device 300 which enables the user 303 to focus their eyes on screen 301 more easily than its opposite interaction. In the just-described opposite interaction which is implemented in some alternative embodiments, the user 303 keeps object 302 steady in their right hand 303R while moving device 300 using their left hand 303L. Such alternative embodiments that implement the just-described opposite interaction require the user to move and/or re-focus their eyes in order to track screen 301 on device 300. Moving the device 300 with the left hand 303L has another disadvantage, namely the camera 310 is likely to be tilted during such movement which results in a large movement of image 309 on screen 301, typically larger than the dimensions of device 300.

Several embodiments evaluate the first and second predetermined conditions described above based on distances and/or movements of object 302 relative to a real world scene 390 (which includes a coffee cup 391). In such embodiments, when object 302 is kept stationary or steady relative to scene 390, the first and second predetermined conditions are not satisfied simply by manual movement of device 300 through distance dX (relative to object 302 and scene 390, both of which are stationary or steady). Instead, such embodiments are designed with the assumption that it is device 300 that is being kept stationary or steady, while object 302 is moved relative to scene 390.

Device 300 remains “steady” (as this term is used in this detailed description) even when device 300 is not strictly stationary. Specifically, device 300 remains “steady” even when device 300 is moved (relative to scene 390) through distances in the real world that are too small to be perceptible by an eye of a human, such as involuntary movements that may be inherent in a hand of the human. Therefore, although camera 310 may move around a little in the real world due to involuntary movement of a hand of the human intending to hold device 300 stationary, any such movement of camera 310 relative to scene 390 is smaller (e.g. three times, five times or even ten times (i.e. an order of magnitude) smaller) than movement through distance dX of object 302 relative to scene 390 that satisfies the second predetermined condition. Hence, some embodiments filter out involuntary movements by use of a threshold in the second predetermined condition.

Several embodiments are designed with no assumption as to device 300 being kept stationary (or steady, depending on the embodiment) relative to scene 390. Instead, device 300 of such embodiments measures a first relative motion between camera 310 and object 302 and also measures a second relative motion between camera 310 and scene 390, and then computes a difference between these two relative motions to obtain a third relative motion between object 302 and scene 390. Device 300 of the just-described embodiments then uses the third relative motion to evaluate a first predetermined condition and/or a second predetermined condition of the type described above.

In an example of the type described above in reference to FIGS. 4A and 4B, any menu-based action of app 320 is quickly and easily selected without the user manually touching any area of screen 301. Instead, user 303 simply holds device 300 steadily in their left hand 303L and moves predetermined object 302 into the vicinity of device 300 with their right hand 303R first to trigger display of a menu on screen 301 (thereby to receive visual feedback), and then continues to use the right hand 303R to further move object 302 through small movements that are sufficient to result in successive displays (and visual feedback) interleaved with successive selections of menu areas, by device 300 repeatedly performing one or more acts of the type shown in FIG. 2A.

In some aspects of described embodiments, repeated movements by user 303, e.g. every hour to view emails received in the last hour, result in a form of training of the user's right hand 303R, so that user 303 automatically performs a specific movement (like a gesture) to issue a specific command to device 300, yielding faster performance than any prior art menu selection techniques known to the current inventor.

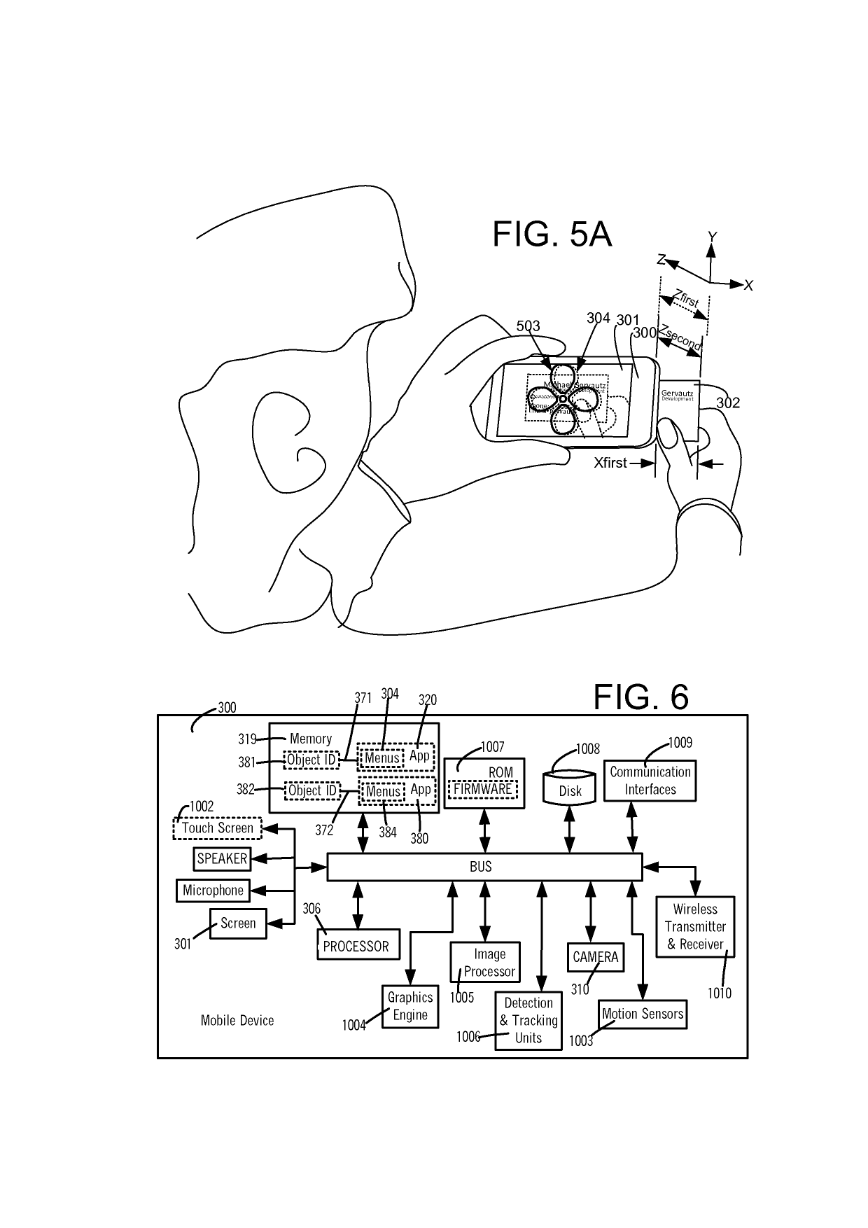

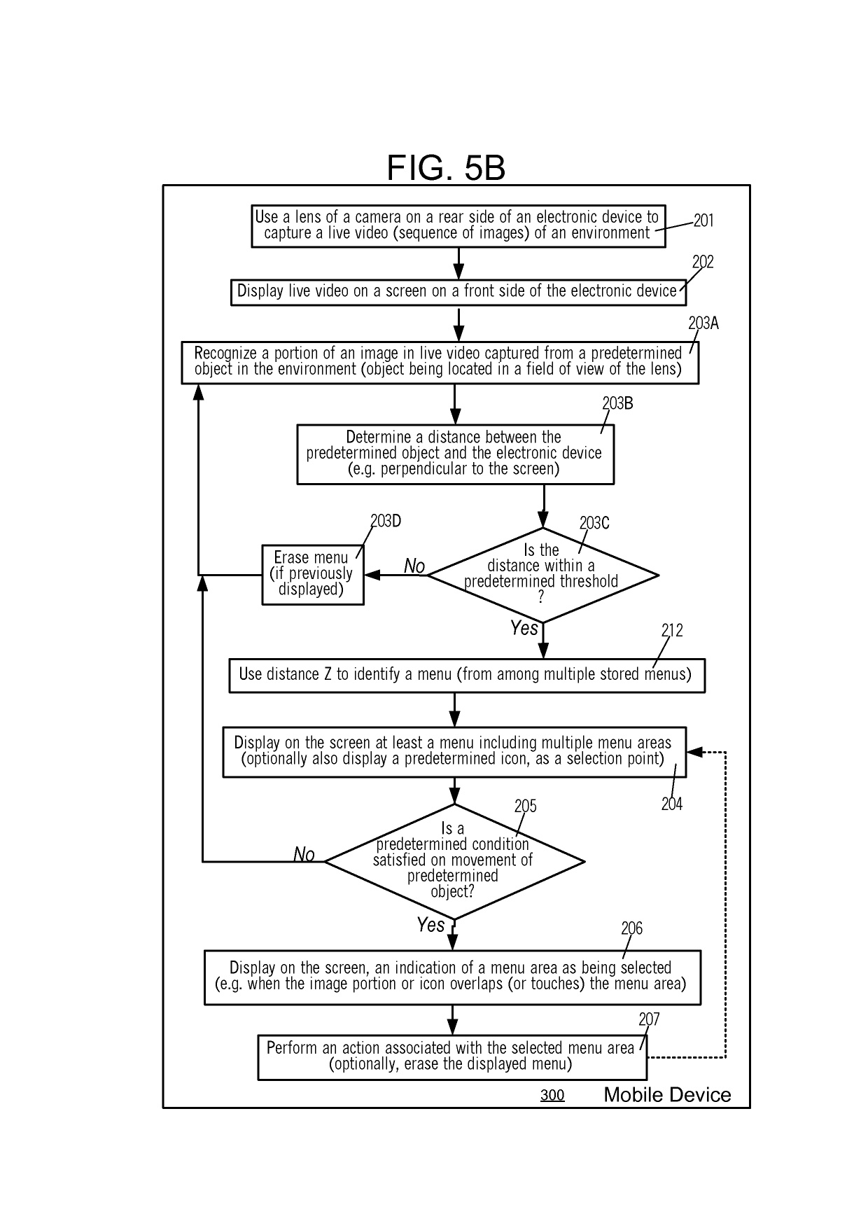

Accordingly, the just-described movement of object 302 to perform a menu selection in device 300 is a new interaction technique that is also referred to herein as target based menus. Target based menus in accordance with several embodiments use movements of object 302 by a user's hand to facilitate complex selections of apps and menus arranged as a layered pie in three dimensions, and successively displayed on screen 301 as described below in reference to FIGS. 5A and 5B. Specifically, in such embodiments, as soon as object 302 is brought within the vicinity of device 300 e.g. at a first threshold distance Zfirst a first menu 304 among multiple layers of menus appears on screen 301 as illustrated in FIG. 3A. In some embodiments, at the center of image 309 appears an icon 308 (e.g. a red dot, an X, or cross-hairs) to be used as a selection point. Icon 308 tracks image 309 of the predetermined object 302 as a target, always staying in the center of image 309. When user 303 moves object 302 to the left, right, up or down in an XY plane that is parallel to screen 301, icon 308 (such as red dot) moves into one of the menu areas (e.g. area 304J in FIG. 3A) as described above in reference to FIGS. 3A and 3B. Therefore, as soon as the icon 308 (e.g. red dot) enters a menu area, that menu area is selected in device 300.

In embodiments of the type shown in FIGS. 5A and 5B, after appearance of first menu 304 if instead of moving object 302 within the XY plane, the user moves object 302 along the Z direction closer to mobile device 300, at a second threshold distance Zsecond the first menu 304 disappears (shown as a pattern of four drops, formed by dotted lines in FIG. 5A) and a second menu 503 among the multiple layers of menus now appears on screen 301 (shown as another pattern of four drops, formed by solid lines in FIG. 5A). Note that in order to display second menu 503 (e.g. based on menu data 330 in FIG. 3C), the user keeps object 302 at approximately the same distance Xfirst (e.g. measured in a plane parallel to screen 301) from device 300, specifically along the X axis within a range around Xfirst less than ±dX (to avoid selection of a menu area in the first menu 304). Therefore, object 302 remains at about the same distance Xfirst (or within the range Xfirst ±dX, wherein dX is predetermined) from device 300 along the X axis, although object 302 is now located in another XY plane that is parallel to screen 301 but now at second threshold distance Zsecond.

To support such a layered pie of menus, a flow of acts illustrated in FIGS. 2A and 2B is changed as illustrated in FIG. 5B by addition of an act 212 between above-described acts 203C and 204. In such embodiments, in act 212, mobile device 300 uses a distance Z along the Z axis (e.g. measured in a direction perpendicular to screen 301) of object 302 to identify a menu, from among multiple menus. The distance Z represents a depth “behind” screen 301 where object 302 is located. In some aspects, a first menu 304 which is displayed on screen 301 is triggered by presence of predetermined object 302 at a distance Z from mobile device 300 within a range Zfirst and Zsecond, wherein Zsecond=Zfirst-dZ. When the predetermined object 302 is moved to closer than Zsecond, a second menu 503 (in another layer) is displayed on screen 301 as shown in FIG. 5A.

In some embodiments, second menu 503 shown in FIG. 5A has menu areas of the same shape, position and number as first menu 304, although these two menus are displayed on screen 301 in different colors and/or different shading or hatching patterns, in order to enable the user to visually distinguish them from one another. Note that an earlier displayed menu 304 of FIG. 3A is shown in dashed lines in FIG. 5A to indicate that it is being replaced by menu 503. Moreover, in some embodiments, the menu areas are labeled with words, to identify the commands associated therewith, although in other embodiments the menu areas are labeled with graphics and/or unlabeled but distinguished from one another by any visual attribute such as shading and/or color. Other embodiments use menu areas of different shapes, positions and numbers, to visually distinguish menus 304 and 503 from one another. Moreover, although only two menus have been illustrated and described, any number of such menus may be included in a mobile device 300 of the type described herein. Accordingly, multiple menus are associated in device 300 with multiple Z axis distances for use in act 212.

In several embodiments, multiple menus of such a layered pie are associated with (or included in) corresponding apps in mobile device 300. Accordingly, associations between multiple menus and their associated apps are predetermined and stored in mobile device 300 ahead of time, for use by a processor 306 in acts 206-209 depending on the Z axis distance. In this way, user 303 is able to select a menu area very quickly from a hierarchy of menus arranged as a layered pie without using any button on device 300 or touching the screen of device 300, e.g. just by performing a gesture like movement with a predetermined object in 3-D space in the vicinity of device 300.

Although in some embodiments a single predetermined object 302 is associated with multiple menus 304 and 503, in other embodiments different menus (or menu hierarchies) are associated with different predetermined objects, by associations that are predetermined and stored in mobile device 300. Specifically, in some embodiments, when object 302 is detected by mobile device 300 in evaluating the first predetermined condition, an identity 381 of object 302 is used with an association 371 in memory 319 to identify a corresponding menu 304 in app 320 (FIG. 6). In the just-described embodiments, when another object having another identity 382 is detected in evaluating the first predetermined condition, identity 382 is used with another association 372 to identify another menu 384 in another app 380 (FIG. 6). Note that if multiple objects having menus associated therewith are present within the vicinity of mobile device 300, device 300 displays only one menu that is associated whichever object is first found to satisfy the first predetermined condition.

Hence, a menu selection technique of the type described herein in reference to FIGS. 2A-2B, 3A-3D, 4A-4B, 5A-5B and 6 can be used with any prior art tangible interaction techniques commonly used in Mobile Augmented Reality (AR) Applications to move virtual objects on a screen, by moving respective objects in a scene in the real world. Users are not forced to change the AR paradigm on which their tangible interaction technique is based, when they perform a more complicated task (sequence of tasks) by use of menu selection as described herein. Maintaining the AR paradigm unchanged when selecting items in a menu reduces the mental load of the user, when performing tangible interactions with augmented reality.

Moreover, as noted above, due to the wide field of view of the optical lens 311 in camera 310 of mobile device 300, even small movements of a predetermined object are magnified into large movements of the corresponding on-screen image. This magnification effect enables user 303 to operate very quickly and perform menu-based tasks via very small movements (similar to movements of a mouse on a mouse pad of a desktop computer). The new technique leads to a speed up in the process. Also, specific selections are related to specific a combined movement (for example up-right).

Several acts of the type described herein are performed by one or more processors 306 included in mobile device 300 (FIG. 6) that is capable of rendering augmented reality (AR) graphics as an indication of regions of the image with which the user may interact. In AR applications, specific “regions of interest” can be defined on an image 309 of a physical real world object (used as predetermined object 302), which region(s) when selected by the user can generate an event that mobile device 300 may use to take a specific action. Such a mobile device 300 (FIGS. 3A-3D) of some embodiments includes screen 301 that is not touch sensitive, because user input is provided via movements of object 302 as noted above. However, alternative embodiments of mobile device 300 include a touch sensitive screen 1002 that is used to support functions unrelated to object-based menu selection as described herein in reference to FIGS. 2A-2B, 3A-3D, 4A-4B, 5A-5B and 6.

Mobile device 300 includes a camera 310 (FIG. 6) of the type described above to generate frames of a video of a real world object that is being used as predetermined object 302. Mobile device 300 may further include motion sensors 1003, such as accelerometers, gyroscopes or the like, which may be used in the normal manner, to assist in determining the pose of the mobile device 300 relative to a real world object that is being used as predetermined object 302. Also, mobile device 300 may additionally include a graphics engine 1004 and an image processor 1005 that are used in the normal manner. Mobile device 300 may optionally include detection and tracking units 1006 for use by instructions 350 (described above) to support AR functionality.

Mobile device 300 may also include a disk (or SD card) 1008 to store data and/or software for use by processor(s) 306. Mobile device 300 may further include a wireless transmitter and receiver in transceiver 1010 and/or any other communication interfaces 1009. It should be understood that mobile device 300 may be any portable electronic device such as a cellular or other wireless communication device, personal communication system (PCS) device, personal navigation device (PND), Personal Information Manager (PIM), Personal Digital Assistant (PDA), laptop, camera, smartphone, or other suitable mobile platform that is capable of creating an augmented reality (AR) environment.

In an Augmented Reality environment there might be different interaction metaphors used. Tangible interaction allows a user 303 to reach into scene 390 that includes various real world objects, such a cup 391 of steaming coffee and a business card being used as predetermined object 302 (FIG. 3A). User 303 can manipulate such real world objects directly in the real world in scene 390 during tangible interaction (as opposed to embodied interaction, where users do interaction directly on the device 300 itself, using one or more parts thereof, such as a screen 301 and/or keys thereon). User's movement of predetermined object 302 in the real world to perform menu selection on screen 301 of device 300 as described herein eliminates the need to switch between the just-described two metaphors (i.e. eliminates a need to switch between tangible interaction and embodied interaction), thereby to eliminate any user confusion arising from the switching. Specifically, when tangible interaction is chosen as an input technique, one or more predetermined objects 302 allow a user to use his hands in the real world scene 390 (to make real world physical movements) while the user's eyes are focused on a virtual three dimensional (3D) world displayed on screen 301 (including a live video of real world scene 390), even when the user needs to select a menu area to issue a command to device 300.

Menu areas that are displayed on screen 301 and selected by real world movements in scene 390 as described herein can have a broad range of usage patterns. Specifically, such menus areas can be used in many cases and applications similar to menu areas on touch screens that otherwise require embodied interaction. Moreover, such menu areas can be used in an AR setting even when there is no touch screen available on mobile phones. Also, use of menu areas as described herein allows a user to select between different tools very easily and also to use the UI of the mobile device in the normal manner, to specify specific commands already known to the user. This leads to much faster manipulation times. Accordingly, menus as described herein cover a broad range of activities, so it is possible to use menus as the only interaction technique for a whole application (or even for many different applications). This means once a user has learned to select items in a menu by tangible interaction with augmented reality (AR) applications as described herein, the user will not need to learn any other tool to issue commands to AR applications.

A mobile device 300 of the type described above may include other position determination methods such as object recognition using “computer vision” techniques. The mobile device 300 may also include means for remotely controlling a real world object that is being used as predetermined object 302 which may be a toy, in response to the user input via menu selection, e.g. by use of transmitter in transceiver 1010, which may be an IR or RF transmitter or a wireless a transmitter enabled to transmit one or more signals over one or more types of wireless communication networks such as the Internet, WiFi, cellular wireless network or other network. The mobile device 300 may further include, in a user interface, a microphone and a speaker (not labeled). Of course, mobile device 300 may include other elements unrelated to the present disclosure, such as a read-only-memory 1007 which may be used to store firmware for use by processor 306.

Although the present invention is illustrated in connection with specific embodiments for instructional purposes, the present invention is not limited thereto. Hence, although item 300 shown in FIGS. 3A and 3D of some embodiments is a mobile device, in other embodiments item 300 is implemented by use of form factors that are different, e.g. in certain other embodiments item 300 is a mobile platform (such as an iPad available from Apple, Inc.) while in still other embodiments item 300 is any electronic device or system. Illustrative embodiments of such an electronic device or system 300 include a camera that is itself stationary, as well as a processor and a memory that are portions of a computer, such as a lap-top computer, a desk-top computer or a server computer.

Various adaptations and modifications may be made without departing from the scope of the invention. Therefore, the spirit and scope of the appended claims should not be limited to the foregoing description. It is to be understood that several other aspects of the invention will become readily apparent to those skilled in the art from the description herein, wherein it is shown and described various aspects by way of illustration. The drawings and detailed description are to be regarded as illustrative in nature and not as restrictive.

1. A method of interfacing with a user through a mobile device, the method comprising:
checking if a first predetermined condition is satisfied, while a live video captured by a camera in the mobile device is being displayed on a screen of the mobile device;
displaying on the screen at least a menu comprising a plurality of menu areas when at least the first predetermined condition is satisfied;
checking if a second predetermined condition is satisfied by a movement of a predetermined object in real world outside the mobile device, while the menu is being displayed on the screen; and
displaying on the screen at least an indication of a menu area in the plurality of menu areas as being selected, when at least the second predetermined condition is satisfied.

2. The method of claim 1 further comprising:
detecting the predetermined object; and
determining a distance in a direction perpendicular to the screen, between the predetermined object and the mobile device;
wherein the first predetermined condition is satisfied when the distance is less than a predetermined threshold distance.

3. The method of claim 2 wherein:
the movement of the predetermined object is relative to a scene of the real world; and
the distance is small enough to ensure that the movement of the predetermined object is scaled up into a corresponding movement of an image of the predetermined object in the live video displayed on the screen.

4. The method of claim 1 wherein:
the menu is displayed overlaid on the live video.

5. The method of claim 4 further comprising:
displaying a predetermined icon overlaid on the live video.

6. The method of claim 5 wherein:
the predetermined icon is automatically moved on the screen in response to the movement of the predetermined object; and
the menu is displayed stationary relative to the screen.

7. The method of claim 5 wherein:
the predetermined icon is displayed stationary relative to the screen; and
the menu is automatically moved on the screen in response to the movement of the predetermined object relative to a scene outside the mobile device.

8. The method of claim 5 wherein:
the second predetermined condition is satisfied when the predetermined icon overlaps the menu area.

9. The method of claim 1 wherein:
subsequent to the menu being displayed on the screen, repeating the checking if the first predetermined condition is satisfied and erasing the menu from the screen when the first predetermined condition is found to be not satisfied by said repeating.

10. The method of claim 1 wherein the menu is hereinafter first menu, and the plurality of menu areas are hereinafter first plurality of menu areas, the method further comprising:
displaying on the screen, a second menu comprising a second plurality of menu areas to replace the first menu comprising the first plurality of menu areas.

11. The method of claim 10 wherein:
the first predetermined condition is met when a distance between the predetermined object and the mobile device is less than a first threshold distance;
the second menu is displayed when the distance is less than a second threshold distance; and
the second threshold distance is less than the first threshold distance.

12. The method of claim 1 wherein:
the indication of the menu area as being selected is displayed without sensing of any touch by the user of the menu on the screen.

13. The method of claim 1 wherein:
the movement of the predetermined object is sensed relative to a scene outside the mobile device; and
the movement of the predetermined object is at least an order of magnitude larger than another movement of the camera relative to the scene.

14. The method of claim 1 further comprising:
identifying the predetermined object from the live video by comparing at least a portion of an image in the live video with a plurality of images of a corresponding plurality of objects including said predetermined object.

15. The method of claim 1 further comprising:
using a predetermined association between the predetermined object and the menu to identify the menu from among a plurality of menus.

16. A system comprising a camera and a screen operatively connected to one another, the system further comprising:
first means for checking if a first predetermined condition is satisfied, while a live video captured by the camera is being displayed on the screen;
second means for rendering a first display on the screen of at least a menu comprising a plurality of menu areas when at least the first predetermined condition is satisfied;
third means for checking if a second predetermined condition is satisfied by a movement of a predetermined object in real world, while the menu is being displayed on the screen; and
fourth means for rendering a second display on the screen of at least an indication of a menu area in the plurality of menu areas as being selected, when at least the second predetermined condition is satisfied.

17. The system of claim 16 wherein:
a predetermined icon is overlaid on a portion of an image of the predetermined object in the first display; and
the predetermined icon moves on the screen in response to the movement of the predetermined object in the real world.

18. The system of claim 16 wherein the menu is hereinafter first menu, the system further comprising:
fifth means for rendering a third display on the screen of at least a second menu comprising a second plurality of menu areas;
wherein the first predetermined condition is met when a distance between the predetermined object and the system is less than a first threshold distance; and
the second menu is displayed when the distance is less than a second threshold distance.

19. The system of claim 16 wherein:
the camera is located on a first side of the system and the screen is located on a second side of the system, the second side being opposite to the first side, with a processor in the system being sandwiched between the first side and the second side.

20. The system of claim 16 further comprising:
fifth means for using a predetermined association between the predetermined object and the menu to identify the menu from among a plurality of menus.

21. A mobile device comprising:
a camera;
a memory operatively connected to the camera;
a screen operatively connected to the memory to display a live video captured by the camera; and
one or more processors operatively connected to the memory;
wherein the memory comprises a plurality of instructions to the one or more processors, the plurality of instructions comprising:
instructions to check whether a first predetermined condition is satisfied, while the live video is being displayed on the screen;
instructions to display on the screen at least a menu comprising a plurality of menu areas when at least the first predetermined condition is found to be satisfied by execution of the instructions to check;
instructions to check whether a second predetermined condition is satisfied by a movement of a predetermined object outside the mobile device, while the menu is being displayed on the screen; and
instructions to display on the screen at least an indication of a menu area as being selected when at least the second predetermined condition is satisfied.

22. The mobile device of claim 21 wherein the plurality of instructions further comprise:
instructions to display on the screen, a predetermined icon overlaid on a portion of an image of the predetermined object; and
instructions to move the predetermined icon on the screen in response to the movement of the predetermined object in real world.

23. The mobile device of claim 21 wherein the menu is hereinafter first menu, the plurality of instructions further comprising:
instructions to display a second menu comprising a second plurality of menu areas;
wherein the first predetermined condition is met when a distance between the predetermined object and the mobile device is less than a first threshold distance; and
wherein the second menu is displayed when the distance is less than a second threshold distance.

24. The mobile device of claim 21 wherein:
the camera is located on a first side of the mobile device and the screen is located on a second side of the mobile device, the second side being opposite to the first side, with the one or more processors and the memory being sandwiched between the first side and the second side.

25. The mobile device of claim 21 wherein the plurality of instructions further comprise:
instructions to use a predetermined association between the predetermined object and the menu to identify the menu from among a plurality of menus.

26. A non-transitory computer readable storage medium comprising:
instructions to one or more processors of a mobile device to check whether a first predetermined condition is satisfied, while the a video is being displayed on a screen of the mobile device;
instructions to the one or more processors to display on the screen at least a menu comprising a plurality of menu areas when at least the first predetermined condition is found to be satisfied by execution of the instructions;
instructions to the one or more processors to check whether a second predetermined condition is satisfied by a movement of a predetermined object outside the mobile device, while the menu is being displayed on the screen; and
instructions to the one or more processors to display on the screen at least an indication of a menu area as being selected when at least the second predetermined condition is satisfied.

27. The non-transitory computer readable storage medium of claim 26 further comprising:
instructions to the one or more processors to display on the screen, a predetermined icon overlaid on a portion of an image of the predetermined object; and
instructions to the one or more processors to move the predetermined icon on the screen in response to the movement of the predetermined object in real world.

28. The non-transitory computer readable storage medium of claim 26 wherein the menu is hereinafter first menu, the non-transitory computer readable storage medium further comprising:
instructions to the one or more processors to display a second menu comprising a second plurality of menu areas;
wherein the first predetermined condition is to be met when a distance between the predetermined object and the mobile device is less than a first threshold distance; and
the second menu is to be displayed when the distance is less than a second threshold distance.

29. The non-transitory computer readable storage medium of claim 26 further comprising:
instructions to the one or more processors to use a predetermined association between the predetermined object and the menu to identify the menu from among a plurality of menus.
